(19) United States
(12) Patent Application Publication
(10) Pub. No.: US 2007/0053686 A1
(43) Pub. Date: Mar. 8, 2007

(54) Image-forming device having an exposing/processing platen

(75) Inventors: Ralph L. Piccinino JR., Rush, NY (US); Paul S. Taylor, Hamlin, NY (US); Somsack Chang, Pittsford, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/221,057

(22) Filed: Sep. 7, 2005

(51) Int. Cl. G03D 9/02

(52) U.S. Cl. 396/583

(57) ABSTRACT

The present invention relates to an image-forming device that comprises a platen device that can support media to be developed during at least the exposure of the media and the development of the media. The media is microencapsulated media and the image-forming device comprises a plurality of rotatable processing members that each include a plurality of micro-members. The micro-members are adapted to contact the microencapsulated media with a force sufficient to rupture unhardened microcapsules on the media.

### CROSS REFERENCE TO RELATED APPLICATIONS

Reference is made to commonly-assigned U.S. patent applications: Ser. No. 10/722,248 filed Nov. 25, 2003, entitled AN IMAGE FORMING DEVICE HAVING A BRUSH TYPE PROCESSING MEMBER to Alphonse D. Camp et al.; Ser. No. 10/851,886 filed May 21, 2004, entitled AN IMAGE FORMING DEVICE HAVING A BELT TYPE PROCESSING MEMBER WITH MICRO-FEATURES to Zhanjun Gao et al.; Ser. No. 10/874,888 filed Jun. 23, 2004, entitled AN IMAGE FORMING DEVICE AND AN EXPOSURE MEMBER FOR THE DEVICE to Alphonse D. Camp; Ser. No. 11/184,756 filed Jul. 19, 2005 entitled AN IMAGE-FORMING DEVICE HAVING BRUSH/DRUM PROCESSOR to Ralph L. Piccinino, Jr. et al. and Serial No. (Docket 89554) filed entitled AN IMAGE-FORMING METHOD AND DEVICE UTILIZING A SHIM MEMBER ARRANGEMENT to Ralph L. Piccinino, Jr. et al.

### FIELD OF THE INVENTION

The present invention relates to an image-forming device for processing photosensitive media, wherein the photosensitive media includes a plurality of microcapsules that encapsulate imaging material such as coloring material.

### BACKGROUND OF THE INVENTION

Image-forming devices are known in which media having a layer of microcapsules containing a chromogenic material and a photohardenable or photosoftenable composition, and a developer, which may be in the same or a separate layer from the microcapsules, is image-wise exposed. In these devices, the microcapsules are ruptured, and an image is produced by the differential reaction of the chromogenic material and the developer. More specifically, in these image-forming devices, after exposure and rupture of the microcapsules, the ruptured microcapsules release a color-forming agent, whereupon the developer material reacts with the color-forming agent to form an image. The image formed can be viewed through a transparent support or a protective overcoat against a reflective white support as is taught in, for example, U.S. Pat. No. 5,783,353 and U.S. Publication No. 2002/0045121 A1. Typically, the microcapsules will include three sets of microcapsules sensitive respectively to red, green and blue light and containing cyan, magenta and yellow color formers, respectively, as taught in U.S. Pat. No. 4,772,541. Preferably a direct digital transmission imaging technique is employed using a modulated LED print head to expose the microcapsules.

Conventional arrangements for developing the image formed by exposure in these image-forming devices include using spring-loaded balls, micro wheels, micro rollers or rolling pins, and heat from a heat source is applied after this development step to accelerate development.

The photohardenable composition in at least one and possibly all three sets of microcapsules can be sensitized by a photo-initiator such as a cationic dye-borate complex as described in, for example, U.S. Pat. Nos. 4,772,541; 4,772,530; 4,800,149; 4,842,980; 4,865,942; 5,057,393; 5,100,755 and 5,783,353.

The above describes micro-encapsulation technology that combines micro-encapsulation with photo polymerization into a photographic coating to produce a continuous tone, digital imaging member. With regard to the media used in this technology, a substrate is coated with millions of light sensitive microcapsules, which contain either cyan, magenta or yellow image forming dyes (in leuco form). The microcapsule further comprises a monomer and the appropriate cyan, magenta or yellow photo-initiator that absorb red, green or blue light respectively. Exposure to light, after the induction period is reached, induces polymerization.

When exposure is made, the photo-initiator absorbs light and initiates a polymerization reaction, converting the internal fluid (monomer) into polymer, which binds or traps leucodye from escaping when pressure is applied.

With no exposure, microcapsules remain soft and are easily broken, permitting all of the contained dye to be expelled into a developer containing binder and developed which produces the maximum color available. With increasing exposure, an analog or continuous tone response occurs until the microcapsules are completely hardened, to thereby prevent any dye from escaping when pressure is applied.

Conventionally, as describe above, in order to develop the image, pressure is uniformly applied across the image. As a final fixing step, heat is applied to accelerate color development and to react all un-reacted liquid from the microcapsules. This heating step also serves to assist in the development of available leucodye for improved image stability. Generally, pressure ruptured capsules (unhardened) expel leucodye into the developer matrix.

Small compact low cost printers typically employed micro-wheels or balls backed by springs and operate in a scanning stylus fashion by transversing the media. This allowed for low cost and relatively low spring force due to the small surface area that the ball or micro wheel (typically 2 to 3 mm diameter) contacted on the media. The disadvantage of this method was that the processing pitch required to assure uniform development needs to be (approximately 1 mm for a 3/16″ diameter ball) which results in slow processing times for a typical print image format (4×6 inch). Ganging multiple ball stylus or micro wheels adds cost, and increases the possibility of processing failure due to debris caught under a ball surface.

Conventional high speed processing involved line processing utilizing large crushing rollers. To ensure the high pressure, (psi) required, these rollers tended to be large to minimize deflection. However, these large rollers were costly, heavy, and require high spring loading. Also, the extensibility of this method is limited as larger rollers (and spring loads) are required as media size increases.

Recent developments in media design (or the imaging member) as described in co-pending U.S. Publication No. 2005/0084783 have changed the prior art structure of the imaging member to the point where the aforementioned means of processing may no longer be robust. The use of a substantially non-compressible top clear polymer film layer and a rigid opaque backing layer which serves to contain the image forming layer of conventional media presented a processing position whereby balls, micro wheels or rollers could be used without processing artifacts such as scratch, banding, or dimensional or surface deformation. In addition, the non-compressibility of this prior art structure provided more tolerance to processing conditions. The recent imaging member embodiment as described in the above-mentioned co-pending patent application, replaces the top and bottom structures of the media with highly elastic and compressible materials (gel SOC) (super over coat or top most clear gel comprising layer) and paper support. The media as described in the above-mentioned co-pending application may no longer survive these means of processing in a robust fashion where pressure is applied by a roller or ball. This is due to the fact that in the imaging member described in the co-pending application, the polyolefin paper backing that is used as fiber base substrates (cellulose fiber) present non uniform density, and the high compression forces required for processing in the conventional arrangements may make an “image” of the fiber pattern in the print, thus making the print corrupt.

It would be advantageous to provide a means or method of processing that did not invoke present methods utilizing high compression forces, to provide a high quality image by improving the tonal scale development and density minimum formation of the imaging member. It would also be advantageous to provide for a processing apparatus that can reduce processing time by having the entire media in contact with a processing member at once.

As mentioned, the need to provide a means of processing that will facilitate the use of the recently designed imaging member is needed. In addition, a processing means that would use plain paper as a substrate would be highly desired. Further, it would be advantageous to provide a means of processing that is low in cost, is fully extensible, and is mechanically simple and robust.

### SUMMARY OF THE INVENTION

The present invention provides for an image-forming device and method that addresses the issues noted above. The image-forming device of the present invention offers the advantages of both types of prior art, i.e., low spring load and fast printing speed.

The present invention addresses the above noted drawbacks by providing for an imaging device, which comprises a plurality of rollers that each include a plurality of micro-members thereon. The rollers are arranged in a spaced manner one behind the other along a direction of movement of media to be processed. Each roller includes a rotational axis that is perpendicular to the direction of movement of the media.

The micro-members on each of the rollers provide for a compliant surface, which can be non-uniform, is self-correcting for unintentional media thickness variations within a print area, and employs shear-like forces more so than compression forces or a combination thereof for development. The use of the micro-members restricts the processing development to the image-forming layer of the media, leaving both the top-most clear gel comprising layer intact and without scratches. Further, the roller of the present invention having the micro-members does not invade the bottom-most backing layer of the media and thus avoids pattern read out of low cost supports. The roller having micro members in accordance with the present invention essentially resembles a brush and thus can be referred to as a brush roller.

The image-forming device of the present invention including the brush roller is fully extensible for all printer applications and is low cost. The composition of the micro members or brushes of the brush roller of the present invention can be varied; for example, where a polymer can be used since it provides a soft contact surface, elasticity, and resiliency, however, any natural or synthetic material meeting these criteria can be employed as the micro-members or brush.

The image-forming device of the present invention also includes a platen device that is located opposite to the rollers so that the media to be processed can pass there-between. In one embodiment of the invention, the platen device is a vacuum platen device that comprises at least an endless belt. The endless belt includes slots thereon for the passage of a vacuum force to hold the media down during processing. The belt is further rotatable to convey the media to and from the processing station. In a further embodiment, the platen device does not include a belt or a vacuum and pinch or drive rollers are provided upstream and downstream of the platen to convey the media.

In a further feature of the invention, post heat rollers are provided downstream of the processing section to fix the image on the media.

The present invention therefore provides for an image forming device that comprises an imaging member adapted to expose a photosensitive medium to form a latent image on the photosensitive medium, with the photosensitive medium comprising a plurality of microcapsules that encapsulate imaging material; a plurality of rotatable processing members adapted to develop the latent image, with each of the processing members comprising a compliant surface that includes micro-members that contact the photosensitive medium during a rotation of each of the processing members to apply a force to a surface of the photosensitive medium, the force being sufficient to release imaging material from said microcapsules, and each of the processing members being provided in a spaced manner along a direction of movement of the photosensitive medium; and a platen device located opposite to the plurality of processing members to permit a passage of the photosensitive medium there-between, with the platen device comprising a plate member having apertures thereon and an endless belt provided around at least the plate member and having a plurality of slots.

The present invention further provides for an image forming method which comprises the steps of exposing a photosensitive medium comprising a plurality of micro-capsules which encapsulate imaging material to form a latent image; developing the latent image by contacting a surface of said medium with a plurality of rotating processing members that each have a compliant surface formed by micro-members, with the contacting of the rotating micro-members with the surface of the medium applying a force to the surface of the medium which is sufficient to release imaging material from the microcapsules; and supporting said photosensitive medium on a platen device during said exposing step and said developing step.

### BRIEF DESCRIPTION OF THE DRAWINGS

FIG. 1A schematically shows an image-forming device;

FIG. 1B schematically shows an example of a pressure applying system that can be used in the image-forming device of FIG. 1A;

FIG. 2 is a perspective view of an image-forming device in accordance with one embodiment of the present invention;

FIG. 3 shows a processing roller of the image-forming device of FIGS. 2A, 2B;

FIG. 4 is a perspective view of a plate member and a platen tray of a platen device of the image-forming device of FIGS. 2A, 2B;

FIG. 5 is a view of the platen device including an endless belt shown in a flat unwrapped state for illustrative purposes; and

FIG. 6 is a perspective view of a further embodiment of an image-forming device in accordance with the present invention.

### DETAILED DESCRIPTION OF THE INVENTION

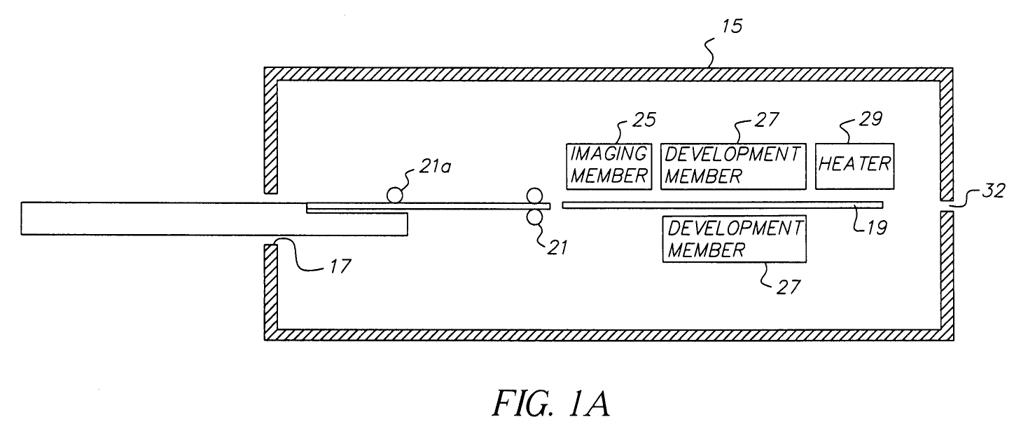

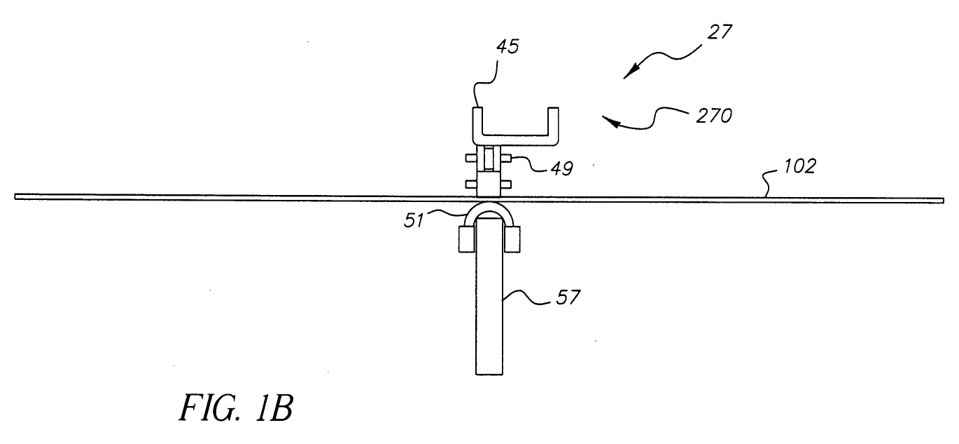

Referring now to the drawings, wherein like reference numerals represent identical or corresponding parts throughout the several views, FIG. 1A is a schematic view of an image-forming device 15 pertinent to the present invention. Image-forming device 15 could be, for example, a printer that includes an opening 17 that is adapted to receive a cartridge containing photosensitive media. As described in U.S. Pat. No. 5,884,114, the cartridge could be a light tight cartridge in which photosensitive sheets are piled one on top of each other. When inserted into image-forming device 15, a feed mechanism that includes, for example, a feed roller 21a in image-forming device 15, working in combination with a mechanism in the cartridge, cooperate with each other to pull one sheet at a time from the cartridge into image-forming device 15 in a known manner. Although a cartridge type arrangement is shown, the present invention is not limited thereto. It is recognized that other methods of introducing media into to the image-forming device such as, for example, individual media feed or roll feed are applicable to the present invention.

Once inside image-forming device 15, photosensitive media travels along media path 19, and is transported by, for example, drive rollers 21 connected to, for example, a driving mechanism such as a motor. The photosensitive media will pass by an imaging member 25 in the form of an imaging head that could include a plurality of light emitting elements (LEDs) that are effective to expose a latent image on the photosensitive media based on image information. After the latent image is formed, the photosensitive media is conveyed past a processing assembly or a development member 27. Processing assembly 27 could be a pressure applicator or pressure assembly, wherein an image such as a color image is formed based on the image information by applying pressure to microcapsules having imaging material encapsulated therein to crush unhardened microcapsules. As discussed above, the pressure could be applied by way of spring-loaded balls, micro wheels, micro rollers, rolling pins, etc.

FIG. 1B schematically illustrates an example of a pressure applicator 270 for processing assembly 27 which can be used in the image-forming device of FIG. 1A. In the example of FIG. 1B, pressure applicator 270 is a crushing roller arrangement that provides a point contact on photosensitive medium 102. More specifically, pressure applicator 270 includes a support 45 that extends along a width-wise direction of photosensitive medium 102. Moveably mounted on support 45 is a crushing roller arrangement 49 that is adapted to move along the length of support 45, i.e., across the width of photosensitive medium 102. Crushing roller arrangement 49 is adapted to contact one side of photosensitive medium 102. A beam or roller type member 51 is positioned on an opposite side of photosensitive medium 102 and can be provided on a support or spring member 57. Beam or roller type member 51 is positioned so as to contact the opposite side of photosensitive medium 102 and is located opposite crushing roller arrangement 49. Beam or roller type member 51 and crushing roller arrangement 49 when in contact with photosensitive medium 102 on opposite sides provide a point contact on photosensitive medium 102. Crushing roller arrangement 49 is adapted to move along a width-wise direction of photosensitive material 102 so as to crush unhardened microcapsules and release coloring material. Further examples of pressure applicators or crushing members that can be used in the image-forming device of FIG. 1A are described in U.S. Pat. Nos. 6,483,575 and 6,229,558.

Within the context of the present invention, the imaging material comprises a coloring material (which is used to form images) or material for black and white media. After the formation of the image, the photosensitive media is conveyed past heater 29 (FIG. 1A) for fixing the image on the media. In a through-feed unit, the photosensitive media could thereafter be withdrawn through an exit 32. As a further option, image-forming device 15 can be a return unit in which the photosensitive media is conveyed or returned back to opening 17.

As previously discussed, conventional arrangements employ spring loaded micro-wheels or ball processing (point processing) to provide a pressure or crushing force to microcapsules of microencapsulated media. The traditional approach for crushing the microcapsules by way of a crushing force applied by balls, wheels or micro-rollers may provide for processing speeds which are in some instances not as fast as desired due to the fact that the development pitch of these arrangements are small, and processing velocity is limited to reasonable bi-directional travel rates. Furthermore, in the traditional ball-crushing arrangements, debris introduced into the printer can cause the ball or micro-wheel to drag the debris over the media to cause a scratching of the image and, thus, render the print unusable.

In order to provide for a higher throughput device, large rollers, which have a width that covers the width of the media, can be utilized. However, these large rollers tend to require high spring loading and may deflect under load. This could adversely affect the application of pressure on the media.

Also, as discussed above, media substrates prone to deformation under the pressure load for development (typically 100 MpA) can jam in the device or irreversibly deform thus rendering the print unusable. In addition, debris entering the processing nip between rollers can cause damage to the roller rendering the processing means unusable.

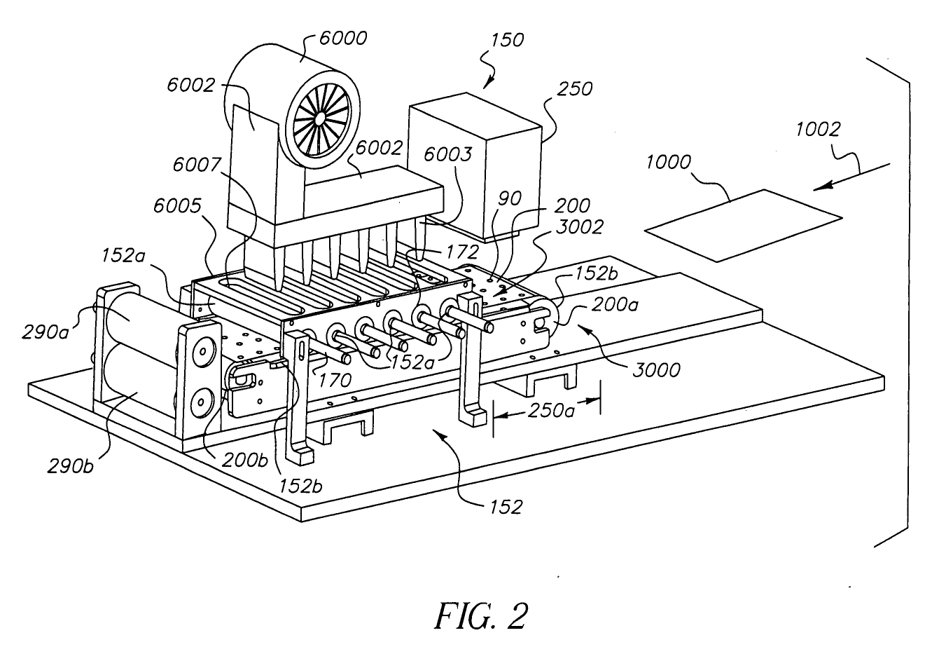

The present invention overcomes the above-noted drawbacks by providing for an image-forming device 150 as shown in FIG. 2. Image-forming device 150 is adapted to accept microencapsulated media 1000 conveyed in a direction as shown by arrow 1002. The media 1000 is conveyed passed an imaging member 250 that can be an imaging head that includes a plurality of light-emitting elements adapted to expose a latent image on the media based on image information. After the latent image is formed, media 1000 is conveyed to a processing section and passed a processing assembly or a development member 152 in accordance with the present invention. Development member 152 comprises a plurality of spaced processing rollers 152a and a backing member. In the embodiment of FIG. 2, the backing member is a platen device 152b that has a top surface that faces the plurality of rollers 152a and has a width that generally matches the width of the media. As also shown in FIG. 2, platen device 152b extends below imaging member 250 and thus supports the media while the media is being exposed and while the media is being processed. Platen device 152b can therefore be defined as an exposing/processing platen.

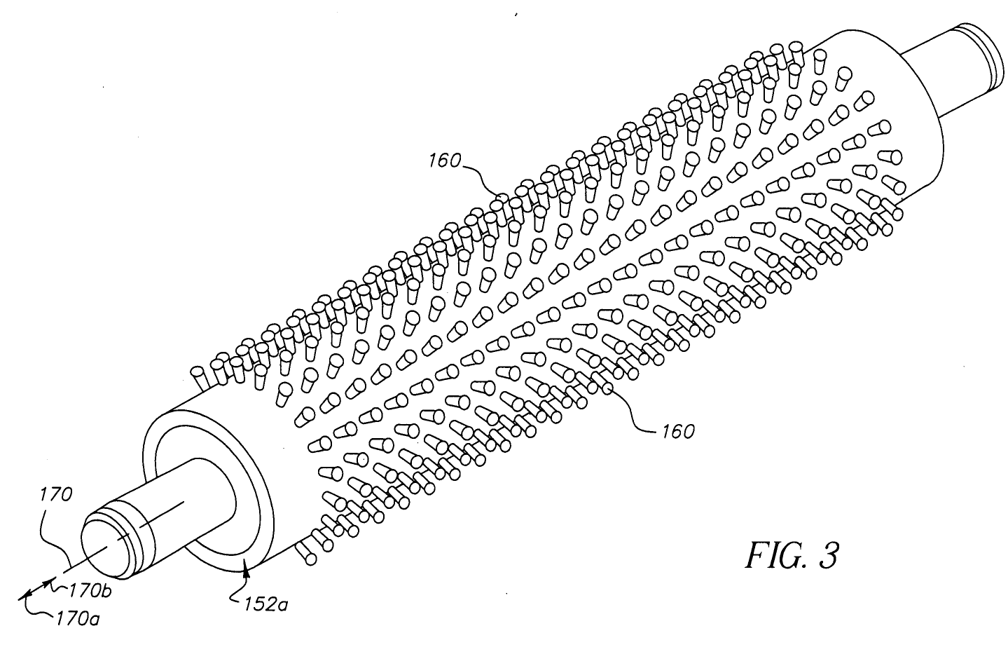

Each of the rollers 152a includes a compliant outer surface, which is adapted to contact microencapsulated photosensitive medium 1000 when it travels between rollers 152a and platen device 152b. More specifically, each of the rollers 152a includes a surface that comprises a plurality of micro-members 160 as shown in FIG. 3. FIG. 3 shows one of the rollers 152a. It is recognized that the remaining rollers 152a of development member 152 would have a similar structure as the roller shown in FIG. 3. In a preferred embodiment, micro-members 160 are hook-like or loop-like members provided on the exterior surface of each of the rollers 152a. Hook or loop-like members 160 define an outer surface on each of the rollers 152a that is compliant and can be non-uniform. With this arrangement, each of the rollers 152a essentially resembles a brush and can also be referred to as a brush roller.

For processing media, each of rollers 152a are preferably tubular type members that can be rotated about a center axis 170 in direction 172, such that micro-members 160, for example, the hooks or loop-like members, contact media 1000 with a rotational or spinning force so as to apply a shear-like force and/or a compressional force onto the top surface of media 1000. With this arrangement, the rotational force applied by micro-members 160 is essentially converted to a compressive or pressure force onto media 1000, which is sufficient to rupture the microcapsules. More specifically, micro-members 160 can be in the form of, for example, plastic loop or hook-like members that are randomly or predeterminedly provided on the outer surface of roller 152a and have random or predetermined heights and locations. The loop or hook-like members 160 provide sufficient force to rupture the capsules. Further, a random positioning in height of hook or loop-like members 160 allow for uniform development of non-uniform media thickness as the plurality of hook or loop-like members 160 impinge on the media and become self-correcting to adapt to media thickness variations.

In a further aspect of the invention, each of the separate loop or hook-like members 160 essentially form a nip-like area with platen device 152b when media 1000 passes there-between. As noted above, micro-members 160 can be plastic. However, the present invention is not limited thereto. It is noted that micro-members 160 can be made of a fiber material or synthetic material. Further, rather than hooks and loops, the outer surface of roller 152a can be a coated cloth. Essentially, outer surface of roller 152a should preferably define a compliant surface that can be non-uniform.

In a feature of the present invention, rotating rollers 152a with micro-members 160 thereon are each sufficient to restrict the processing development to the image forming layer of media 1000, while leaving both the top most clear gel comprising layer intact and without scratches. Further, rollers 152a with micro-members 160 thereon does not invade the bottom-most backing layer of media 1000 and thus, avoids pattern readout of low-cost media supports.

In the embodiment of FIG. 2, each of the rollers 152a has a width that matches the width of media 1000, but is preferably larger than the width of the media to eliminate any alignment issues. Therefore, the rollers are effective to crush all the unhardened microcapsules and release imaging material to form an image. The imaging material that is released from the microcapsules comprises a coloring material that is used to form the image or material for black and white media. After formation of the image, the photosensitive media is conveyed between heated rollers 290a and 290b for fixing the image on the media. Either one or both rollers 290a, 290b can be heated through the use of a heating element such as a thermocouple. In a through-feed unit, the photosensitive media could thereafter be withdrawn from the imaging device through an exit. As a further option, image-forming device 150 can be a return unit in which the photosensitive media is conveyed to or returned back to an entrance of the device.

FIG. 3 is a more detailed view of the structure of rollers 152a and micro-members 160 on rollers 152a. As shown, roller 152a can be a tubular member that has an outer surface with plurality of micro-members 160 thereon. In the embodiment of FIG. 3, micro-members 160 are hook-like or loop-like members, which can be made of a plastic or resilient material. Additionally, as further described above, micro-members 160 can be provided on the outer surface of roller member 152a in a random or predetermined pattern with respect to location and height. The multiple loop or hook-like members 160 on roller member 152a essentially define an outer compliant surface for roller 152a, which compensates for any non-uniform surfaces of the media. In essence, each roller 152a can be self-correcting for media thickness variations and each of the hook or loop-like members 160 define a nip-like area with the opposing surface of platen device 152b that permits the passage of media there-between while at the same time developing the image on the media. Further, any dust, dirt or debris which enters into a vicinity of each roller 152a will not get caught onto the outer surface of the roller 152a, since the outer surface of each roller 152a comprises the multiple loop or hook-like members 160 which will not trap the dust or debris therein. Further, the rotating motion of hook or loop-like members 160 will tend to clear away any dust or dirt within the vicinity of roller 152a.

With regard to the rotation of rollers 152a, this can be achieved through the use of a motor drive and belt or drive member that is adapted to rotate each of the rollers 152a upon actuation of the motor. As a further option, the drive from the motor to each of the rollers 152a can be achieved through a gearing arrangement.

In addition to rotating or spinning, each of the rollers 152a can be adapted to oscillate or reciprocate in directions 170a, 170b as shown in FIG. 3, which are directions perpendicular to the direction of travel 1002 of media 1000. The oscillation of rollers 152b can be achieved through the use of a motor and driving members such as rack gears, a gear train, a belt, etc. As a further option, the oscillating motion can be achieved through the use of cam members associated with each roller that are effective to convert the rotating motion of the cam to a linear motion for each roller. The combination of the rotation and oscillation of each of the rollers 152a assures complete processing of the entire surface area of the media in a rapid manner.

In a further feature of the invention, as shown in FIG. 2, platen device 152b extends below imaging member 250 and after exposure of the media, preferably a sheet, the media is conveyed along platen device 152b to development member 152. In a preferred embodiment of the invention, the entire sheet is conveyed between the rollers 152a and facing surface of platen device 152b prior to initiating the rotation and/or oscillation of rollers 152a. In this way, the entire media is processed at once. After processing, the media is them conveyed to post-heat rollers 290a, 290b. Since the platen device 152b extends from exposure section 250a to development member 152, there is no gap or hand-off of the media from the exposure section 250a to the development member 152. This provides for a rapid conveyance of the media. Further, since the entire media is located in development member 152 prior to the initiation of the rotation and/or oscillation of the rollers 152a, uniform processing of the entire sheet while stably supported on the platen device 152b can be achieved at once. This prevents the occurrence of having a leading end of the media undergoing processing while the trailing end of the media is being exposed, which can lead to a non-uniform processing or exposure since two processes can be occurring on the media at once. For example, the processing of the leading end of the media by applying pressure to the media may provide unstable exposure results to the trailing end of the media.

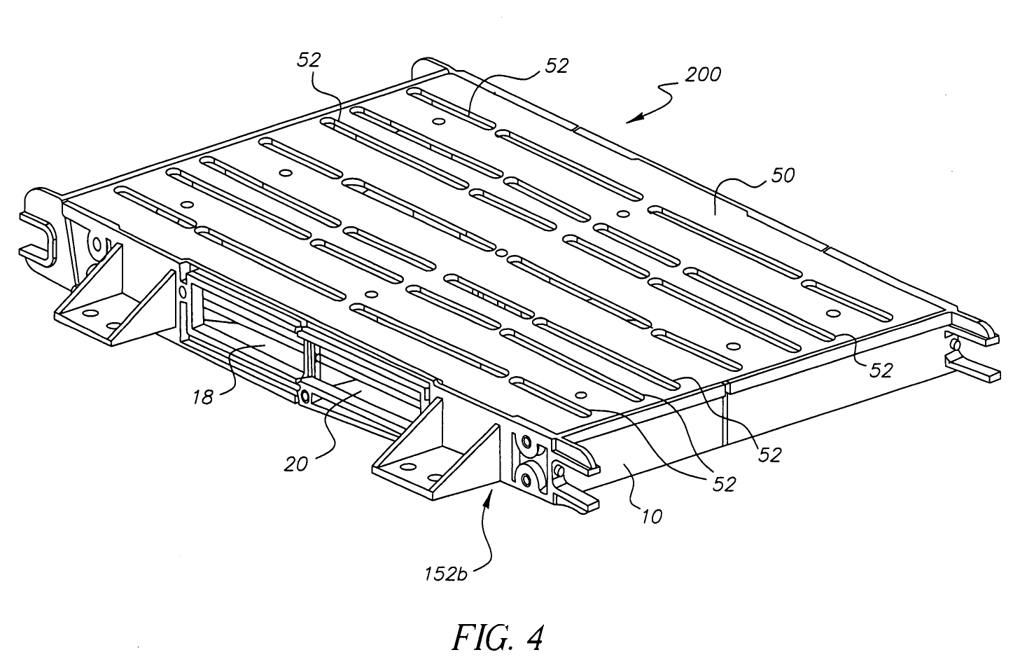

In order to convey the media from the exposure section 250a to the development member and then to the post-heat rollers, in one embodiment of the present invention, platen device 152b is a vacuum platen device that includes a platen tray 10 (FIG. 4) and an endless belt 200 (FIG. 2). As illustrated in FIG. 2, endless belt 200 is wrapped around the entire platen device.

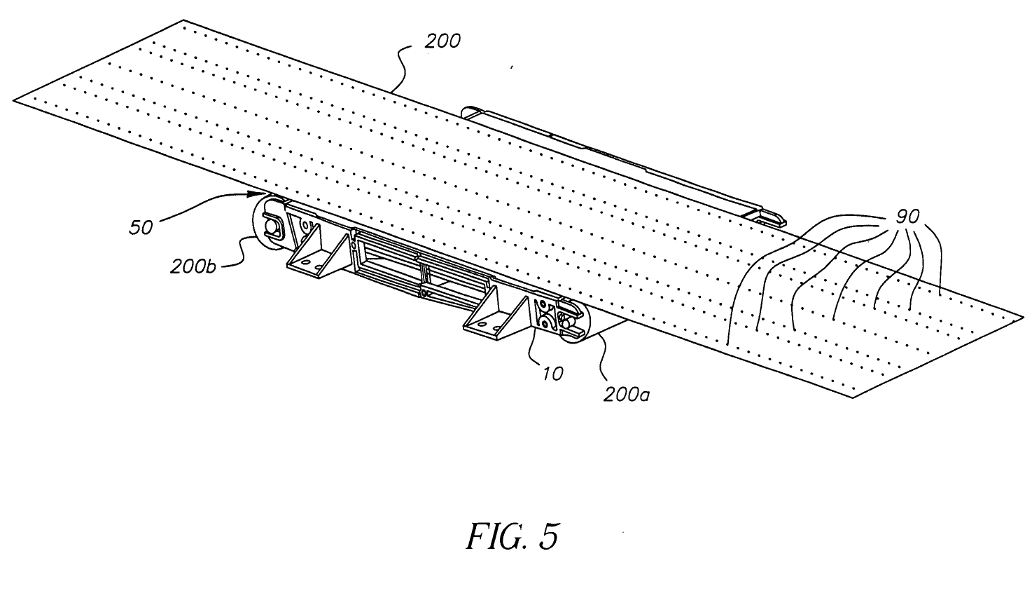

FIGS. 4-5 depict an embodiment of a vacuum platen device in accordance with one embodiment of the present invention. As shown in FIG. 4, the vacuum platen device includes vacuum platen tray 10. Platen tray 10 has a top portion and a bottom portion. The tray 10 is used to transport the media and has an interior that includes at least one vacuum chamber that is associated with a vacuum source. The tray can be made from plastic to reduce weight and lower manufacturing costs. Steel, stainless steel, aluminum, or coated metals can be used if cost of manufacturing or weight is not a concern.

One or more vacuum ports can be formed in the vacuum platen tray 10 to control vacuum to the tray and the chamber formed by at least the tray. FIG. 4 depicts two vacuum ports 18 and 20 disposed in one wall of the vacuum platen tray 10. The ports are preferably specifically large enough not to clog with debris, thereby reducing maintenance costs and improving operation reliability

As also shown in FIG. 4, the platen device also includes a plate member 50 disposed on the top of the vacuum platen tray 10 to form a part of the vacuum platen device. The plate member 50 can be secured to the tray 10 by a variety of known mounting or fastening devices.

The plate member 50 is preferably made out of aluminum and is attached to the top of the vacuum platen tray 10. The plate member 50 can be made of coated metal, or it can be a laminate. It should be noted in alternative embodiments that the plate member 50 can alternatively be composed of plastic or other non-deformable materials.

The plate member 50 includes a plurality of slots or apertures that communicate with the chamber in the platen tray. More specifically, as shown in FIG. 4, slots or apertures 52 can be provided on plate member 50. In a preferred embodiment, the slots are elongated, elliptical slots. The slots are parallel to each other in the preferred embodiment with the length of the slot being longer than the width. The slots or apertures can be formed in parallel rows and positioned to provide an effective holding force for media being conveyed on the platen device.

Referring to FIGS. 2 and 5, belt 200 can be provided around the platen device and two rollers 200a, 200b, wherein at least one of the rollers is a driven roller. Therefore, rotation of rollers 200a, 200b in direction 3000 (FIG. 2) through the use of any known drive means causes a movement of belt 200, such that the portion of belt 200 which faces rollers 152a moves in the direction shown by arrow 3002. This enables the conveyance of the media through the image-forming device.

FIG. 5 shows a top view of belt 200 with slots or holes 90 disposed throughout the belt. Slots 90 are also shown in FIG. 2. In the view of FIG. 5, belt 200 is shown in a flat or non-wrapped no-loop state for illustrative purposes. Belt 200 is preferably a woven material, such as a synthetic rubber. In a preferred embodiment, black neoprene rubber or an impregnated woven endless polyester fiber can be used to construct the endless belt 200. Springs can be used to keep the belt 200 tensioned around the vacuum platen device.

Therefore for conveyance purposes, a vacuum from a known source can be applied via ports 18, 20 (FIG. 4) to vacuum tray 10. The suction force is applied to media being processed through apertures 52 on the plate member 50 and holes 90 on the belt 200, and serves to hold the media down on the vacuum platen device while the media is being exposed at the exposure section, while the media is being transported to the development member, while the media is being processed at the development member, and while the media is being conveyed to the post heat rollers.

More specifically, in a preferred embodiment of the invention, media 1000 is conveyed by movement of belt 200 while the media is held down by a suction force applied through holes 90 on belt 200. In this manner, the media is conveyed from the exposure section (250a, FIG. 2) to the development member 152 and passes between rollers 152a and platen device 152b. When the media is completely positioned under rollers 152a, the rollers are rotated and/or oscillated. The rotating and oscillating forces of rollers 152a on media 1000 causes loop or hook-like members 160 to contact the top surface of media 1000 with a spinning and/or shearing motion that essentially is converted to a pressure on media 1000 to cause a rupture of the non-hardened microcapsules to release coloring material. This rotating and oscillating motion, however, will not cause a scratching of the surface of media 1000. In a preferred embodiment, in order to assure development of the image, the media moves at a line velocity that is different from the spinning velocity of rollers 152a to ensure a shearing action. Also, rollers 152a can spin or rotate at various velocities in accordance with design considerations, however, faster velocities provide for a higher probability of more micro-members 160 striking the microcapsules on the media, which improves development.

In a further feature of the invention as shown in FIG. 2, the rollers 152a can be rotatably supported on a structure 6005 that supports each of the rollers in a spaced manner as shown. Structure 6005 preferably includes openings 6007 located in an area above each of rollers 152a. An air blower 6000 having an air path 6002 and air outlets 6003 can be provided such that an air output area of each air outlet 6003 faces an opening 6007 of structure 6005. This arrangement permits the application of cooling air onto each of rollers 152a which is effective to keep at least the nip portion between the rollers and the media cool.

Further, although rollers 152a are shown as spinning in direction 172, the present invention is not limited thereto. Rollers 152a can also spin in a direction opposite to direction 172 or tangentially to the direction of movement of media 1000.

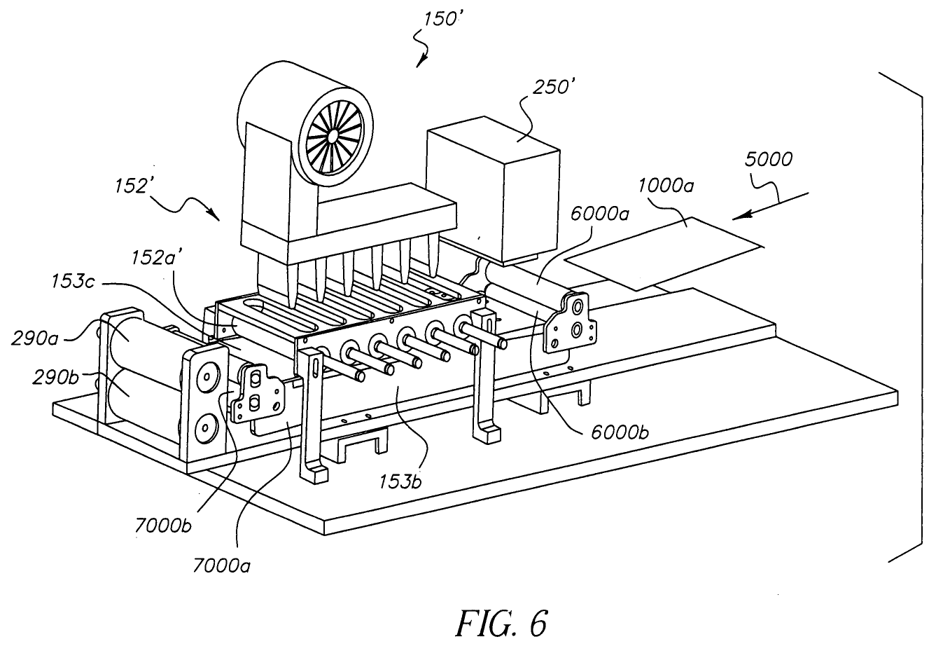

In the embodiment of FIG. 2, the preferable media to utilize are cut sheets since the cut sheets can be fed one at a time onto platen device 152b and transferred from the exposure section to the processing section, where the entire sheet is processed at once. FIG. 6 illustrates a further embodiment of the image-forming device of the present invention where it is preferable to use a roll sheet fed media. In the embodiment of FIG. 6, media 1000a can be fed from any type of roll feed mechanism in direction 5000. Image-forming device 150′ of FIG. 6 includes an imaging member 250′ similar to the imaging member 250 of FIG. 2, as well as a pressure development member 152′. Pressure development member 152′ includes a plurality of processing rollers 152a′ provided in a spaced manner along the direction of movement of the media, similar to processing rollers 152a of FIG. 2.

Processing rollers 152a′ are preferably rollers that include a compliant surface of micro members thereon as shown and described with reference to FIGS. 2 and 3. Development member 152′ further includes a platen device 153b. Platen device 153b differs from platen device 152b in that platen device 153b is not a vacuum platen, does not have a belt wrapped around the platen device and does not include slots on a surface of the upper platen. More specifically, platen device 153b basically provides a support for the rolled sheet fed media while the media is being exposed by imaging member 250′ and while the media is being processed by development member 152′. That is, platen device 153b includes a surface 153c which faces processing rollers 152a′ to permit the passage of media therebetween. For the purposes of conveying the media, imaging device 150′ includes an entrance pair of drive or pinch rollers 6000a, 6000b and an exit pair of drive or pinch rollers 7000a, 7000b. Therefore, in order to process media 1000a, a predetermined amount of media is metered out from a roll and introduced between pinch or drive rollers 6000a, 6000b. For the purposes of driving the media into imaging device 150′, a known leader can be attached to the leading end of the media with the leader or leader card being threaded between pinch rollers 6000a, 6000b, through development member 152′ and through pinch rollers 7000a and 7000b, until the first part of the media to be exposed is located below imaging device 250′. Imaging device 250′ is then activated to expose the media and the leader card is thereafter moved to move the media to be exposed between processing rollers 152a′ and platen device 153b. At this point, processing rollers 152a′ can be rotated and oscillated in a manner similar to that as described with reference to FIG. 2, to develop the exposed images on the media. Thereafter, the media can be driven out from development member 152′ via drive or pinch rollers 7000a and 7000b to post-heat rollers 290a, 290b.

Therefore, with the embodiment of FIG. 6, entrance drive or pinch rollers 6000a, 6000b and exit drive or pinch rollers 7000a, 7000b are effective to drive roll fed media into imaging device 150′ and from the imaging device 150′; and further hold the media while the media is supported on platen device 153b and between platen device 153b and rotating processing rollers 152a′ during development.

In a feature of the described embodiments, the processing rollers can be adapted to be moved away from the surface of the media or platen device. The advantage of having the rollers being movable away from the top surface of the platen device is to prevent the brushes on the rollers from wearing out by inadvertently hitting the top surface of the platen device. This can be achieved by mounting the ends of each of the rollers in an elongated slot and using any known drive means to move the rollers individually or as a group (for example, all of the rollers) away from and toward the top surface of the platen device.

The invention has been described in detail with particular reference to certain preferred embodiments thereof, but it will be understood that variations and modifications can be effected within the spirit and scope of the invention.

1. An image forming device comprising:
an imaging member adapted to expose a photosensitive medium to form a latent image on the photosensitive medium, the photosensitive medium comprising a plurality of microcapsules which encapsulate imaging material;
a plurality of rotatable processing members adapted to develop the latent image, each of said processing members comprising a compliant surface that includes micro-members that contact the photosensitive medium during a rotation of each of the processing members to apply a force to a surface of the photosensitive medium, said force being sufficient to release imaging material from said microcapsules, each of said processing members being provided in a spaced manner along a direction of movement of the photosensitive medium; and
a platen device located opposite to the plurality of processing members to permit a passage of the photosensitive medium there-between, said platen device comprising a platen having apertures thereon and an endless belt provided around the platen and having a plurality of slots.

2. An image forming device according to claim 1, wherein said micro-members are a plurality of hook or loop like members which extend from an outer surface of each of said processing members.

3. An image forming device according to claim 1, wherein said processing members are tubular members which extend in a width-wise direction perpendicular to a direction of movement of the media, and said micro-members are a plurality of hook or loop like members which extend from an outer surface of tubular member.

4. An image forming device according to claim 1, wherein each of processing rollers are further adapted to be oscillated in opposite directions along a rotational axis of each of said processing rollers.

5. An image forming device according to claim 1, wherein said platen device comprises a plate member and a platen tray which define a vacuum chamber therein, said plate member comprising a plurality of apertures such that a suction force provided to said vacuum chamber passes through said apertures on said plate member and said slots in said belt to hold media on said platen device.

6. An image-forming device according to claim 1, wherein said belt is movable relative to said platen device to convey the media through said image-forming device.

7. An image forming device according to claim 1, further comprising a post heat roller pair located downstream of said processing rollers to fix the image on said photosensitive medium.

8. An image-forming device according to claim 1, wherein said photosensitive medium are cut sheets of photosensitive medium.

9. An image forming method comprising:
exposing a photosensitive medium comprising a plurality of micro-capsules which encapsulate imaging material to form a latent image;
developing the latent image by contacting a surface of said medium with a plurality of rotating processing members that each have a compliant surface formed by micro-members, said contacting of the rotating micro-members with the surface of the medium applying a force to the surface of the medium which is sufficient to release imaging material from the microcapsules; and
supporting said photosensitive medium on a platen device during said exposing step and said developing step.

10. An image forming method according to claim 9, wherein said platen device comprises an endless belt wrapped around said platen device, such that said method further comprises the step of conveying the media by moving the belt.

11. An image forming method according to claim 10, wherein said belt comprises slots and said platen device includes a plate member having apertures, said method further comprising applying a vacuum suction force to said platen device which passes through said apertures on said plate member and said slots on said belt to hold said media on said platen device during said conveying step, said exposing step and said developing step.

12. An image forming device according to claim 9, comprising the further step of fixing the image on the photosensitive medium after said development step by passing said photosensitive medium between a pair of post-heat rollers.

13. An image forming method according to claim 9, further comprising the steps of supplying the photosensitive medium to be exposed and developed onto said platen device by passing the photosensitive medium between a pair of entrance drive rollers, and removing the developed medium from said platen device by passing the developed medium between a pair of exit drive rollers.

14. An image forming method according to claim 9, comprising the further step of conveying the developed medium from said pair of exit drive rollers to a pair of post-heat rollers to fix the image on said medium.

15. An image forming method according to claim 9, wherein said micro-members comprise a plurality of hook or loop-like members located on a surface of each of said processing members.

16. An image forming method according to claim 9, wherein during said developing step, the medium is conveyed between the rotating processing members and said platen device.
